(19) United States
(12) Patent Application Publication
(10) Pub. No.: US 2025/0079556 A1
(43) Pub. Date: Mar. 6, 2025

(54) BATTERY ASSEMBLY FOR HEAT DISSIPATION

(71) Applicant: Caterpillar Inc., Peoria, IL (US)

(72) Inventors: Peitong JIN, Dunlap, IL (US); Wellington Y. KWOK, Dunlap, IL (US); Strauss LANGRUD, Peoria, IL (US); Cason STURHAHN, Morton, IL (US); Jake WOHLD, St. Charles, IL (US); Jimmy KLANK, Winfield, IL (US); Jose ALBITER, LaSalle, IL (US)

(73) Assignee: Caterpillar Inc., Peoria, IL (US)

(21) Appl. No.: 18/461,317

(22) Filed: Sep. 5, 2023

(51) Int. Cl. H01M 10/653; H01M 10/613; H01M 10/647; H01M 10/6554; H01M 10/6556; H01M 50/105; H01M 50/211; H01M 50/264; H01M 50/291

(52) U.S. Cl. CPC H01M 10/653; H01M 10/613; H01M 10/647; H01M 10/6554; H01M 10/6556; H01M 50/105; H01M 50/211; H01M 50/264; H01M 50/291

(57) ABSTRACT

A battery assembly may include a pouch cell assembly. The pouch cell assembly may include a pouch cell battery including a pouch having a first surface, and a second surface opposite the first surface. The pouch cell assembly may include a first thermal sheet on the first surface and overhanging the pouch. The pouch cell assembly may include a second thermal sheet on the second surface and overhanging the pouch. The pouch cell assembly may include a compression element on the first thermal sheet. The battery assembly may include a frame having a first edge, and a second edge opposite the first edge. The frame may have a first ledge projecting, in a first direction, from the first edge and defining a space containing the pouch cell assembly, and a second ledge projecting, in a second direction opposite the first direction, from a second edge of the frame.

### TECHNICAL FIELD

The present disclosure relates generally to batteries and, for example, to a battery assembly for heat dissipation.

### BACKGROUND

A machine may include one or more battery packs to provide power to components of the machine, such as lights, computer systems, and/or a motor, among other examples. A battery pack may be associated with a modular design that includes multiple battery modules. A battery module may include multiple battery cells. One type of battery cell is a pouch cell, which includes a battery device contained in a flexible pouch. The pouch provides little protection and may allow the pouch cell to be folded, bent, or otherwise damaged under some operating conditions. In some cases, a pouch cell may be used with a frame that provides structural support to the pouch cell. However, the frame may limit accessible areas of the pouch cell, thereby placing a constraint on systems used with the pouch cell to dissipate heat.

China Patent No. 216648430 (the '430 patent) discloses a battery cell shell that includes a shell and a graphite layer. The '430 patent indicates that the graphite layer may be a heat-conducting graphite sheet structure. The '430 patent states that the graphite coats the battery cell to achieve heat dissipation. However, the '430 patent does not describe the graphite layer in the context of a heat dissipation system, or indicate a configuration for the graphite layer that is suitable for interfacing with a heat dissipation system. Furthermore, the graphite layer of the '430 patent coats much less than a total accessible surface area of the battery cell, such that a full heat dissipating potential is not exploited.

The pouch cell assembly and battery assembly of the present disclosure solve one or more of the problems set forth above and/or other problems in the art.

### SUMMARY

A battery assembly may include a pouch cell assembly. The pouch cell assembly may include a pouch cell battery including a pouch having a first surface, and a second surface opposite the first surface. The pouch cell assembly may include a first thermal sheet on the first surface and overhanging the pouch. The pouch cell assembly may include a second thermal sheet on the second surface and overhanging the pouch. The pouch cell assembly may include a compression element on the first thermal sheet. The battery assembly may include a frame having a first edge, and a second edge opposite the first edge. The frame may have a first ledge projecting, in a first direction, from the first edge and defining a space containing the pouch cell assembly, and a second ledge projecting, in a second direction opposite the first direction, from a second edge of the frame.

A battery module may include a battery assembly. The battery assembly may include a pouch cell assembly. The pouch cell assembly may include a pouch cell battery including a pouch having a first surface, and a second surface opposite the first surface. The pouch cell assembly may include a first thermal sheet on the first surface. The pouch cell assembly may include a second thermal sheet on the second surface. The pouch cell assembly may include a compression element on the first thermal sheet. The battery assembly may include a frame defining a space to contain the pouch cell assembly. The battery module may include a housing, containing the battery assembly. The housing may include a first heat exchanger plate, defining a top wall of the housing, thermally contacting the first thermal sheet. The housing may include a second heat exchanger plate, opposite the first heat exchanger plate and defining a bottom wall of the housing, thermally contacting the second thermal sheet. The battery assembly may be disposed between the first heat exchanger plate and the second heat exchanger plate.

A pouch cell assembly may include a pouch cell battery including a pouch having a first surface, and a second surface opposite the first surface. The first surface and the second surface may be joined at a first edge of the pouch, and at a second edge of the pouch opposite the first edge. The pouch cell assembly may include a first thermal sheet on the first surface. The first thermal sheet may overhang the first edge. The pouch cell assembly may include a second thermal sheet on the second surface. The second thermal sheet may overhang the second edge. The pouch cell assembly may include a compression element on the first thermal sheet.

### BRIEF DESCRIPTION OF THE DRAWINGS

FIG. 1 is a diagram of an example battery pack.

FIG. 2 is a sectional view of an example pouch cell assembly.

FIG. 3 is a perspective view of an example frame.

FIG. 4 is a sectional view of an example battery assembly.

FIG. 5 is an exploded view of an example of a pouch cell assembly between adjacent frames of a battery assembly stack.

FIG. 6 is a perspective view of an example battery assembly stack.

FIG. 7 is a perspective view of an example battery module.

### DETAILED DESCRIPTION

This disclosure relates to a battery assembly, battery module, and/or battery pack, and is applicable to any machine application that uses power provided by a battery. For example, the machine may perform an operation associated with an industry, such as mining, construction, farming, transportation, or any other industry. For example, the machine may be an electric or hybrid vehicle, or an electric or hybrid work machine (e.g., a compactor machine, a paving machine, a cold planer, a grading machine, a backhoe loader, a wheel loader, a harvester, an excavator, a motor grader, a skid steer loader, a tractor, and/or a dozer), among other examples. Additionally, or alternatively, the battery assembly, battery module, and/or battery pack described herein may be used in an energy storage application, such as for solar energy storage and/or wind energy storage, among other examples. As used herein, “battery cell,” “battery,” and “cell” may be used interchangeably.

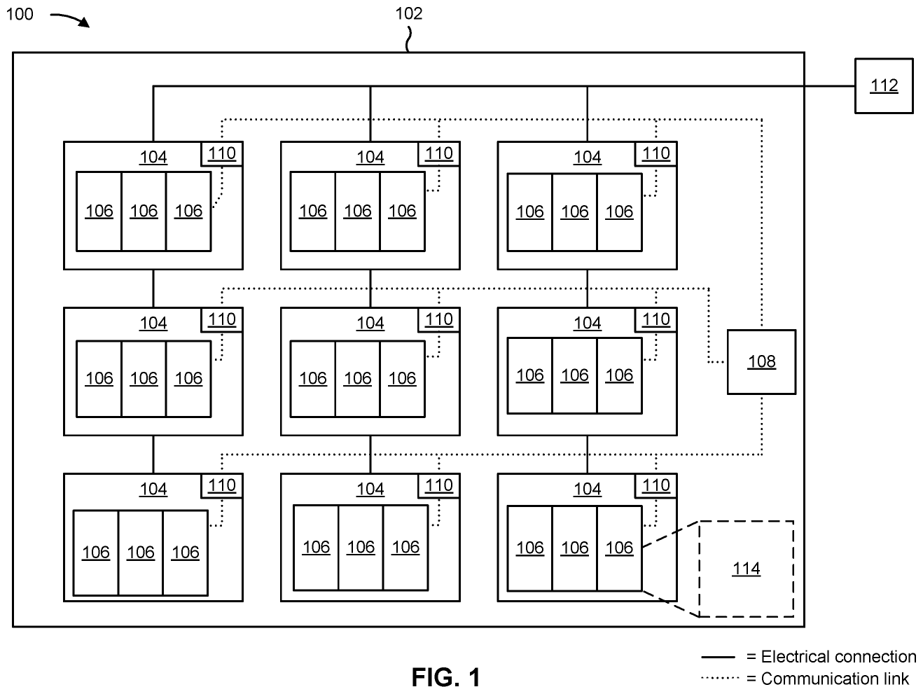

FIG. 1 is a diagram of an example battery pack 100. The battery pack 100 may include a battery pack housing 102, one or more battery modules 104, and one or more battery assemblies 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as a computing system or an electric motor, among other examples. As another example, the component 112 provides energy to the battery pack 100 (e.g., to be stored by the battery assemblies 106). In such examples, the component 112 may be a power generator, a solar energy system, and/or a wind energy system, among other examples.

The battery pack housing 102 may include metal shielding (e.g., steel, aluminum, or the like) to protect elements (e.g., battery modules 104, battery assemblies 106, the battery pack controller 108, the module controllers 110, wires, circuit boards, or the like) positioned within battery pack housing 102. Each battery module 104 includes one or more (e.g., a plurality of) battery assemblies 106 (e.g., positioned within a housing of the battery module 104). As shown, a battery assembly 106 includes a battery cell 114. Battery cells 114 may be connected in series and/or in parallel within the battery module 104 (e.g., via terminal-to-busbar welds). Each battery cell 114 is associated with a chemistry type. The chemistry type may include lithium ion (Li-ion) (e.g., lithium ion polymer (Li-ion polymer), lithium iron phosphate (LFP), and/or nickel manganese cobalt (NMC)), nickel-metal hydride (NiMH), and/or nickel cadmium (NiCd), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery assemblies 106 included in each battery module 104, and the number of battery modules 104 included in the battery pack 100 (e.g., and the relative serial and/or parallel connections of the battery cells 114 and/or the battery modules 104) may be associated with the required output power and an intended use of the battery pack 100. For example, any number of battery cells 114 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery assemblies 106. The one or more parameters may include cell voltages, temperatures, chemistry types, a cell energy throughput, a cell internal resistance, and/or a quantity of charge-discharge cycles of a battery module 104, among other examples.

As indicated above, FIG. 1 is provided as an example. Other examples may differ from what is described with regard to FIG. 1.

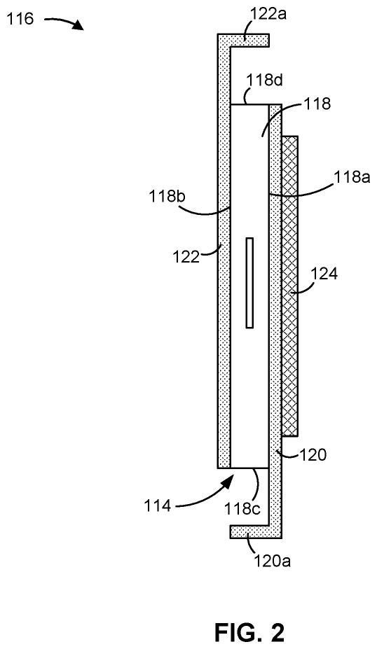

FIG. 2 is a sectional view of an example pouch cell assembly 116. The pouch cell assembly 116 may be included in a battery assembly 106. The pouch cell assembly 116 includes a battery cell 114, which is a pouch cell battery in the example of FIG. 2. A pouch cell battery may include a pouch 118 (e.g., flexible casing, such as a soft, polymer-lined aluminum pouch) that contains an electrolyte and a set of battery layers. The set of battery layers may include an anode electrode layer, a cathode electrode layer, and a separator layer between the anode electrode layer and the cathode electrode layer.

The pouch 118 has a first surface 118a and a second surface 118b opposite the first surface 118a. The first surface 118a and the second surface 118b are joined at a first edge 118c of the pouch 118, and at a second edge 118d of the pouch 118 opposite the first edge 118c (e.g., the first edge 118c and the second edge 118d are parallel). The first edge 118c and the second edge 118d may be associated with a major dimension of the pouch 118. The pouch 118 also has a third edge and a fourth edge associated with a minor dimension of the pouch 118. A first tab (e.g., a first terminal) associated with (e.g., electrically connected to, or part of) the anode electrode layer of the set of battery layers may extend from the third edge of the pouch 118, and a second tab (e.g., a second terminal) associated with (e.g., electrically connected to, or part of) the cathode electrode layer of the set of battery layers may extend from the fourth edge of the pouch 118.

The pouch cell assembly 116 includes a first thermal sheet 120 and a second thermal sheet 122. A thermal sheet 120 or 122 may include a material that is thermally conductive (e.g., graphite, copper, aluminum, gold, or the like). In some implementations, a thermal sheet 120 or 122 may include a graphite sheet. A thermal sheet 120 or 122 may have a thickness in a range from 0.01 millimeters (mm) to 0.10 mm. A thermal sheet 120 or 122 may have a density in a range from 1.5 grams (g) per cubic centimeter (cm) to 2.0 g/cm³. A thermal sheet 120 or 122 may have an in-plane thermal conductivity in a range from 1,050 watts (W) per meter (m)-Kelvin (K) to 1,800 W/m·K.

The first thermal sheet 120 may be on (e.g., thermally contacting) the first surface 118a of the pouch 118. The second thermal sheet 122 may be on (e.g., thermally contacting) the second surface 118b of the pouch 118. For example, the first thermal sheet 120 and the second thermal sheet 122 may be in a stacked arrangement with the pouch 118, such that the pouch 118 is between the first thermal sheet 120 and the second thermal sheet 122. The thermal sheets 120, 122 may be attached to the pouch 118 by an adhesive. For example, the adhesive may be a thermally-conductive adhesive. Additionally, or alternatively, the thermal sheets 120, 122 may be attached to the pouch 118 by physical compression.

The first thermal sheet 120 may be folded into an L-shape (e.g., when the pouch cell assembly 116 is introduced in the battery assembly 106). Moreover, the first thermal sheet 120 may be arranged with respect to the pouch 118 to overhang the pouch 118 (e.g., the first thermal sheet 120 overhangs the first edge 118c of the pouch 118). For example, the first thermal sheet 120 may have a bend (e.g., the first thermal sheet 120 may be folded at 90 degrees) defining a portion 120a of the first thermal sheet 120 (e.g., overhanging the pouch 118) extending over the first edge 118c of the pouch 118 toward the second surface 118b (e.g., when the pouch cell assembly 116 is introduced in the battery assembly 106). The second thermal sheet 122 also may be folded into an L-shape (e.g., when the pouch cell assembly 116 is introduced in the battery assembly 106). Moreover, the second thermal sheet 122 may be arranged with respect to the pouch 118 to overhang the pouch 118 (e.g., the second thermal sheet 122 overhangs the second edge 118d of the pouch 118). For example, the second thermal sheet 122 may have a bend (e.g., the second thermal sheet 122 may be folded at 90 degrees) defining a portion 122a of the second thermal sheet 122 (e.g., overhanging the pouch 118) extending over the second edge 118d of the pouch 118 toward the first surface 118a (e.g., when the pouch cell assembly 116 is introduced in the battery assembly 106). As an example, an orientation of the second thermal sheet 122 may be rotated 180 degrees relative to an orientation of the first thermal sheet 120 (e.g., when the pouch cell assembly 116 is introduced in the battery assembly 106).

The pouch cell assembly 116 includes a compression element 124. The compression element 124 may include a sheet, or multiple sheet segments, of an elastomeric material. The compression element 124 may include a foam material. The compression element 124 may be on the thermal sheet 120 or 122. For example, the compression element 124 may be on the first thermal sheet 120, as shown. As an example, the compression element 124 may be in a stacked arrangement with the first thermal sheet 120, such that the pouch cell assembly 116 includes a set of layers including, in order, the second thermal sheet 122, the battery cell 114, the first thermal sheet 120, and the compression element 124.

As indicated above, FIG. 2 is provided as an example. Other examples may differ from what is described with regard to FIG. 2.

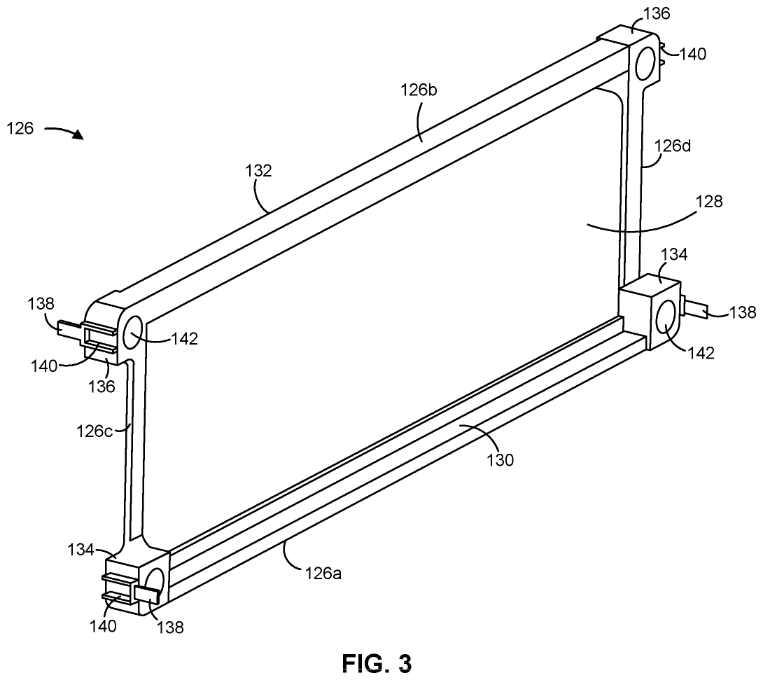

FIG. 3 is a perspective view of an example frame 126. The frame 126 may be included in a battery assembly 106. The frame 126 may be composed of a polymer, such as a plastic. The frame 126 may be molded.

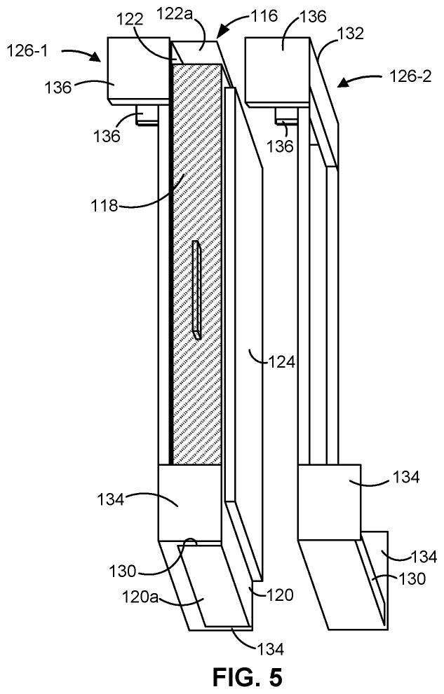

The frame 126 has a first edge 126a, a second edge 126b opposite the first edge 126a, a third edge 126c, and a fourth edge 126d opposite the third edge 126c. The first edge 126a, the second edge 126b, the third edge 126c, and the fourth edge 126d define a perimeter structure that surrounds a central opening 128 of the frame 126. The frame 126 may have a first ledge 130 projecting from the first edge 126a of the frame 126 in a first direction. The first ledge 130 may define a space to contain a pouch cell assembly 116 of the battery assembly 106. The frame 126 may have a second ledge 132 projecting from the second edge 126b of the frame 126 in a second direction opposite the first direction. The second ledge 132 may define a space to receive an additional pouch cell assembly 116 of an additional battery assembly 106, as described in connection with FIG. 5.

The frame 126 may include one or more connection elements to connect the frame 126 to adjacent frame(s) and/or end frame(s) of a battery assembly stack, as described in connection with FIG. 5. For example, the frame 126 may include a first set of connection elements 134 and a second set of connection elements 136. The connection elements 134, 136 may include blocks having a cross-section in a shape of a square, a rectangle, a circle, or another suitable shape.

Clips 138 may extend from one or more of the connection elements 134 and/or one or more of the connection elements 136. The clips 138 may be configured to engage catches (e.g., grooves, ledges, detents, or the like) of connection elements of an additional frame assembly. For example, a clip 138 may be a cantilever clip configured to deflect between a disengaged position and an engaged position with respect to a catch. Catches 140 may be defined in one or more of the connection elements 134 and/or one or more of the connection elements 136. The catches 140 may be configured to engage clips of connection elements of an additional frame assembly. A connection element 134, 136 including a catch 140 may also include an unlatching hole (not shown) configured to facilitate unlatching of a clip from a catch 140 (e.g., by inserting a pin into the unlatching hole to deflect the clip).

In this way, adjacent frames may be connected to form a battery assembly stack, as described in connection with FIG. 5. In some implementations, each connection element 134, 136 may include a clip 138 and a catch 140. In some implementations, a first connection element 134 or a first connection element 136 may include a clip 138 and a second connection element 134 or a second connection element 136 may include a catch 140.

The first ledge 130 may extend along a portion of the first edge 126a. The first ledge 130 may extend between respective connection elements 134. For example, the connection elements 134 may be located at corners of the frame 126 (e.g., a first connection element 134 at a corner of the first edge 126a and the third edge 126c, and a second connection element 134 at a corner of the first edge 126a and the fourth edge 126d). Similarly, the second ledge 132 may extend along a portion of the second edge 126b. The second ledge 132 may extend between respective connection elements 136. For example, the connection elements 136 may be located at corners of the frame 126 (e.g., a first connection element 136 at a corner of the second edge 126b and the third edge 126c, and a second connection element 136 at a corner of the second edge 126b and the fourth edge 126d).

The connection elements 134, 136 may also project from the frame 126. The connection elements 134 may project from the frame 126 beyond the first ledge 130, thereby defining a recess that is between the connection elements 134 and extends to an exterior surface of the first ledge 130 (e.g., with a rounded corner), that allows a thermal sheet to pass between adjacent frames of a battery assembly stack. For example, the recess is configured to receive the portion 120a of the first thermal sheet 120 that extends along the exterior surface of the first ledge 130. Similarly, the connection elements 136 may project from the frame 126 beyond the second ledge 132, thereby defining a recess that is between the connection elements 136 and extends to an exterior surface of the second ledge 132 (e.g., with a rounded corner), that allows a thermal sheet to pass between adjacent frames of a battery assembly stack. For example, the recess is configured to receive a portion 122a of a second thermal sheet 122, of an additional pouch cell assembly 116, that extends along the exterior surface of the second ledge 132.

The connection elements 134, 136 may include respective apertures 142. An aperture 142 is configured to receive a compression limiter. A compression limiter received in an aperture 142 may project slightly from a connection element, thereby limiting an amount of compression imparted to a compression element 124 of a battery assembly by an adjacent battery assembly. A compression limiter may have an annular shape configured to receive a compression rod, as described herein. An inner surface of a compression limiter may be lined with rubber or polytetrafluoroethylene to aid in insertion of a compression rod, as well as to provide vibration dampening and minimize stress on the compression rod.

As indicated above, FIG. 3 is provided as an example. Other examples may differ from what is described with regard to FIG. 3.

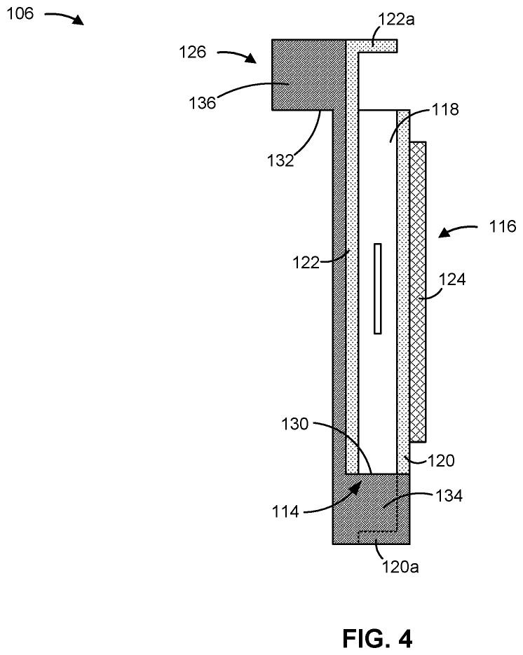

FIG. 4 is a sectional view of an example battery assembly 106. The battery assembly 106 includes the pouch cell assembly 116, described in connection with FIG. 2, and the frame 126, described in connection with FIG. 3. As shown, the pouch cell assembly 116 may be disposed in the space defined by the first ledge 130 and between the connection elements 134. For example, the pouch 118 may abut, or rest on, the first ledge 130. Moreover, the portion 120a of the first thermal sheet 120 may extend along an exterior surface of the first ledge 130. For example, the portion 120a of the first thermal sheet 120 may fold around the first ledge 130 to define a thermal contact.

As indicated above, FIG. 4 is provided as an example. Other examples may differ from what is described with regard to FIG. 4.

FIG. 5 is an exploded view of an example of a pouch cell assembly 116 between adjacent frames 126 (designated as frame 126-1 and frame 126-2) of a battery assembly stack. As shown, the pouch cell assembly 116 may be disposed in the space defined by the first ledge 130 and between the connection elements 134 of the frame 126-1, as described in connection with FIG. 4. For example, the portion 120a of the first thermal sheet 120 may fold around the first ledge 130 of the frame 126-1 to define a thermal contact. The second ledge 132 of the frame 126-2 may be between the pouch 118 and the portion 122a of the second thermal sheet 122. Thus, the portion 122a of the second thermal sheet 122 may fold around the second ledge 132 of the frame 126-2 (e.g., extending along an exterior surface of the second ledge 132) to define a thermal contact. The frames 126-1 and 126-2 may be joined together by couplings between the connection elements 134, 136 of the frame 126-1 to connection elements 134, 136 of the frame 126-2, as described in connection with FIG. 3.

The compression element 124 may be sized to extend into the central opening of the frame 126-2. For example, an area of the compression element 124 may be less than or equal to an area of the central opening. Accordingly, in the battery assembly stack, the compression element 124 is compressed between the first surface 118a of the pouch 118 and the second surface 118b of an adjacent pouch 118 associated with the frame 126-2. In other words, compression elements 124 may be between each pair of adjacent pouch cell assemblies 116 of the battery assembly stack.

As indicated above, FIG. 5 is provided as an example. Other examples may differ from what is described with regard to FIG. 5.

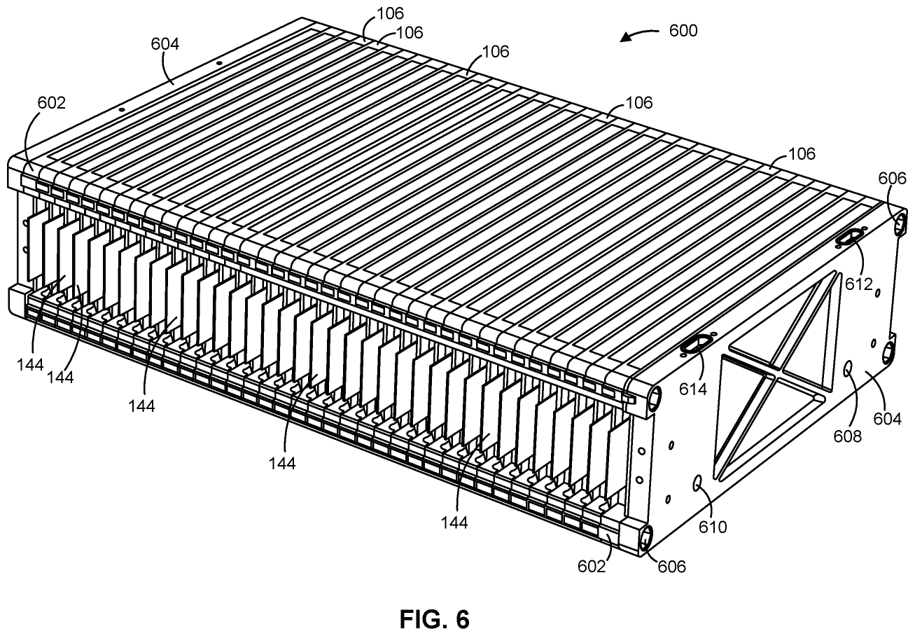

FIG. 6 is a perspective view of an example battery assembly stack 600. The battery assembly stack 600 includes a plurality of battery assemblies 106 arranged side-by-side, in a similar manner as described in connection with FIG. 5. A quantity of the battery assemblies 106 may be based on an overall voltage and/or energy capacity to be produced by the battery assembly stack 600 (e.g., in accordance with series or parallel cell configuration).

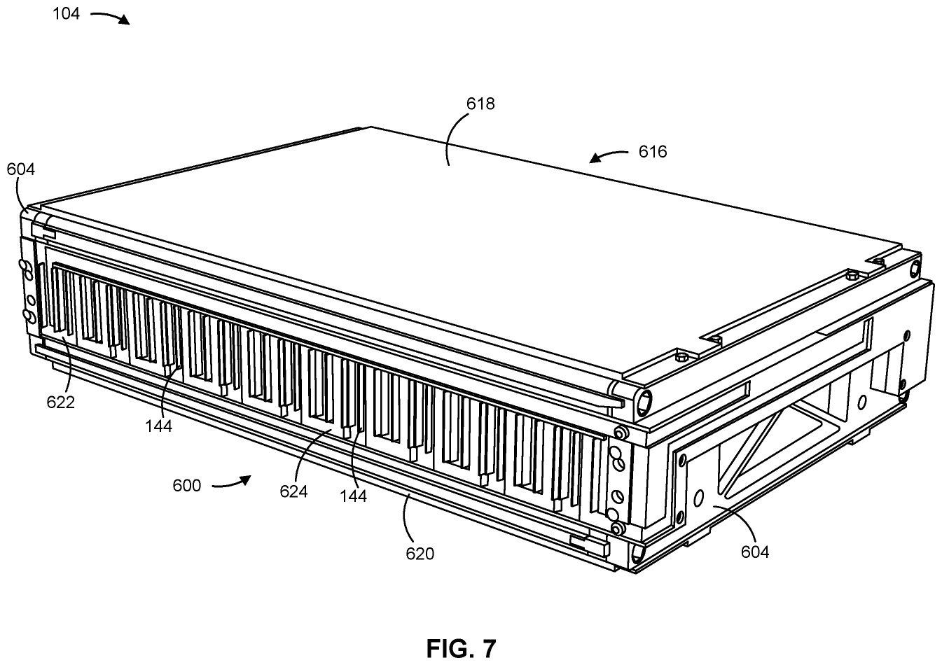

In some implementations, frames 126 of battery assemblies 106 at each end of the battery assembly stack 600 may be attached to end frames 602. An end frame 602 may be similar to a frame 126, described herein, but may have only a single ledge and a single set of connection elements, thereby terminating the battery assembly stack 600. Moreover, end plates 604 of a housing (described in connection with FIG. 7) may be positioned at ends of the battery assembly stack 600. For example, a first end plate 604 may be adjacent to a first end frame 602, and a second end plate 604 may be adjacent to a second end frame 602. An end plate 604 may include one or more apertures 606 configured to receive a compression rod (not shown). For example, when arranged as the battery assembly stack 600, the apertures 142 of the frames 126 may be in alignment, and may also align with apertures of the end frames 602 and the apertures 606 of the end plates 604. Accordingly, a compression rod (e.g., four compression rods in total, at each corner of the battery assembly stack 600) may be received through a row of aligned apertures to connect and compress the battery assembly stack 600 (e.g., the battery assembly stack 600 is pressed between the end plates 604, and packed down by compression of the compression elements 124, as limited by the compression limiters, to a particular displacement).

An end plate 604 may include a fluid inlet 608 and a fluid outlet 610. The fluid inlet 608 may be in fluid communication with a fluid passageway 612 extending in-plane through the end plate 604. Similarly, the fluid outlet 610 may be in fluid communication with a fluid passageway 614 extending in-plane through the end plate 604. As shown, tabs 144 (e.g., terminal tabs) of the battery cells 114 of the battery assemblies 106 of the battery assembly stack 600 may be exposed at sides of the battery assembly stack 600.

As indicated above, FIG. 6 is provided as an example. Other examples may differ from what is described with regard to FIG. 6.

FIG. 7 is a perspective view of an example battery module 104. The battery module 104 includes the battery assembly stack 600 (e.g., including at least one battery assembly 106) and a housing 616. The housing 616 may include a first heat exchanger plate 618, defining a top wall of the housing 616, and a second heat exchanger plate 620 that is opposite and parallel to the first heat exchanger plate 618 and defining a bottom wall of the housing 616. The housing 616 further includes the end plates 604 (e.g., defining a front wall and a back wall of the housing 616), described in connection with FIG. 6. For example, a first end plate 604 may extend between the first heat exchanger plate 618 and the second heat exchanger plate 620 at a first end of the housing 616, and a second end plate 604 may extend between the first heat exchanger plate 618 and the second heat exchanger plate 620 at a second end of the housing 616. Additionally, the housing 616 includes a first side wall 622 extending between first ends of the first end plate 604 and the second end plate 604, and a second side wall 622 (not visible in FIG. 7) that is opposite and parallel to the first side wall 622 and extending between second ends of the first end plate 604 and the second end plate 604.

The heat exchanger plates 618, 620, the end plates 604, and the side walls 622 define an enclosure to contain the one or more battery assemblies 106 of the battery assembly stack 600. For example, the one or more battery assemblies 106 of the battery assembly stack 600 are disposed between the first heat exchanger plate 618 and the second heat exchanger plate 620, disposed between the first end plate 604 and the second end plate 604, and disposed between the first side wall 622 and the second side wall 622.

The first heat exchanger plate 618 may be configured to thermally contact a thermal contact defined by the portion 120a of the first thermal sheet 120 of a pouch cell assembly 116 of each battery assembly 106 in the battery assembly stack 600. The second heat exchanger plate 620 may be configured to thermally contact a thermal contact defined by the portion 122a of the second thermal sheet 122 of a pouch cell assembly 116 of each battery assembly 106 in the battery assembly stack 600. Furthermore, each heat exchanger plate 618, 620 may have one or more fluid passageways (not shown), extending in-plane through the heat exchanger plate 618, 620, to transport fluid (e.g., a coolant, such as water) across a length of the heat exchanger plate 618, 620. The one or more fluid passageways may be in fluid communication with (e.g., and form a fluid seal with) the fluid passageway 612 and the fluid passageway 614 of an end plate 604 (e.g., to receive cool fluid via the fluid inlet 608 of an end plate 604 and to eject warmed fluid via the fluid outlet 610 of the end plate 604), thereby defining one or more fluid loops (e.g., coolant loops).

The first side wall 622 includes one or more slots configured to receive respective first tabs 144 (e.g., terminals) of battery cells 114 of the one or more battery assemblies 106 of the battery assembly stack 600. Similarly, the second side wall 622 includes one or more slots configured to receive respective second tabs 144 (e.g., terminals) of the battery cells 114. The tabs 144 may connect to positive or to negative busbars 624 (e.g., intercell busbars) extending along the side walls 622. The busbar(s) 624 may be configured to connect with cell voltage and/or cell temperature monitoring circuitry (e.g., at each side of the battery module 104), as well as to connect to a main power terminal on an end plate 604. In some implementations, the battery module 104 may include a protective cover (not shown) that contains the housing 616 and the battery assembly stack 600.

As indicated above, FIG. 7 is provided as an example. Other examples may differ from what is described with regard to FIG. 7.

### INDUSTRIAL APPLICABILITY

The battery assembly described herein may be used in any battery module used to power a load or used for energy storage. For example, the battery assembly may be used in a battery module used to power an electric or hybrid vehicle or work machine, or for use in an energy storage application (e.g., associated with solar or wind power generation, or the like). As described herein, the battery assembly may include a pouch cell and a frame. In general, a frame used to protect a pouch cell may limit accessible areas of the pouch cell, thereby placing a constraint on systems used with the pouch cell to dissipate heat. Poor heat dissipation from the pouch cell can reduce a useful life of the pouch cell, cause damage to the pouch cell, or the like.

The battery assembly described herein provides a protective frame for a pouch cell, while improving heat dissipation from the pouch cell. In particular, the battery assembly may include thermally-conducting sheets disposed on both surfaces of the pouch cell's pouch to provide in-plane heat transfer to an external cooling medium (e.g., a liquid-filled cold plate), thereby efficiently utilizing a total surface area of the pouch for heat dissipation. The thermally-conducting sheets may be L-shaped and extend to, and fold over, exterior surfaces of the frame to thereby provide a large surface area of the sheets for directly contacting the external cooling medium. Furthermore, the use of two thermally-conducting sheets in the battery assembly allows for thermal contacts to be defined on opposite sides of the battery assembly, such that two cooling plates (e.g., a top cooling plate and a bottom cooling plate) can be used to provide heat transfer. In this way, the battery assembly provides improved heat dissipation from the pouch cell. Accordingly, the battery assembly may prevent damage to the pouch cell and/or increase a useful life of the pouch cell.

What is claimed is:

1. A battery assembly, comprising:
a pouch cell assembly, comprising:
a pouch cell battery including a pouch having a first surface, and a second surface opposite the first surface;
a first thermal sheet on the first surface and overhanging the pouch;
a second thermal sheet on the second surface and overhanging the pouch; and
a compression element on the first thermal sheet; and
a frame having a first edge, and a second edge opposite the first edge,
the frame having a first ledge projecting, in a first direction, from the first edge and defining a space containing the pouch cell assembly, and a second ledge projecting, in a second direction opposite the first direction, from a second edge of the frame.

2. The battery assembly of claim 1, wherein the first ledge extends between respective connection elements of a first set of connection elements of the frame.

3. The battery assembly of claim 2, wherein clips, configured to engage catches of connection elements of another frame, extend from each of the respective connection elements.

4. The battery assembly of claim 3, wherein catches, configured to engage clips of another frame, are defined in each of the respective connection elements.

5. The battery assembly of claim 2, wherein the second ledge extends between respective connection elements of a second set of connection elements of the frame.

6. The battery assembly of claim 1, wherein the first thermal sheet has a bend that defines a portion of the first thermal sheet that extends toward the second surface, and
wherein the second thermal sheet has a bend that defines a portion of the second thermal sheet that extends toward the first surface.

7. The battery assembly of claim 6, wherein the portion of the first thermal sheet extends along an exterior surface of the first ledge of the frame.

8. The battery assembly of claim 7, wherein the frame includes a recess to receive the portion of the first thermal sheet that extends along the exterior surface of the first ledge.

9. A battery module, comprising:
a battery assembly, comprising:
a pouch cell assembly, comprising:
a pouch cell battery including a pouch having a first surface, and a second surface opposite the first surface;
a first thermal sheet on the first surface;
a second thermal sheet on the second surface; and
a compression element on the first thermal sheet; and
a frame defining a space to contain the pouch cell assembly; and
a housing, containing the battery assembly, comprising:
a first heat exchanger plate, defining a top wall of the housing, thermally contacting the first thermal sheet; and
a second heat exchanger plate, opposite the first heat exchanger plate and defining a bottom wall of the housing, thermally contacting the second thermal sheet,
the battery assembly disposed between the first heat exchanger plate and the second heat exchanger plate.

10. The battery module of claim 9, wherein the housing further comprises:
a first end plate extending between the first heat exchanger plate and the second heat exchanger plate,
wherein the first end plate includes one or more first fluid passageways extending in-plane through the first end plate; and
a second end plate extending between the first heat exchanger plate and the second heat exchanger plate,
wherein the second end plate includes one or more second fluid passageways extending in-plane through the second end plate.

11. The battery module of claim 10, wherein the first heat exchanger plate includes one or more fluid passageways in fluid communication with the one or more first fluid passageways and the one or more second fluid passageways, and
wherein the second heat exchanger plate includes one or more fluid passageways in fluid communication with the one or more first fluid passageways and the one or more second fluid passageways.

12. The battery module of claim 10, wherein the housing further comprises:
a first side wall extending between the first end plate and the second end plate,
wherein the first side wall has a slot configured to receive a first tab of the pouch cell battery; and
a second side wall extending between the first end plate and the second end plate,
wherein the second side wall has a slot configured to receive a second tab of the pouch cell battery.

13. The battery module of claim 9, wherein the first thermal sheet has a bend that defines a portion of the first thermal sheet, overhanging the pouch, that extends toward the second surface, and
wherein the second thermal sheet has a bend that defines a portion of the second thermal sheet, overhanging the pouch, that extends toward the first surface.

14. The battery module of claim 13, wherein the portion of the first thermal sheet extends along an exterior surface of a ledge projecting from an edge of the frame.

15. The battery module of claim 14, further comprising:
an additional battery assembly in a stack with the battery assembly,
wherein the portion of the second thermal sheet extends along an exterior surface of a ledge projecting from a frame of the additional battery assembly.

16. A pouch cell assembly, comprising:
a pouch cell battery including a pouch having a first surface, and a second surface opposite the first surface,
the first surface and the second surface joined at a first edge of the pouch, and at a second edge of the pouch opposite the first edge;
a first thermal sheet on the first surface,
the first thermal sheet overhanging the first edge;
a second thermal sheet on the second surface,
the second thermal sheet overhanging the second edge; and
a compression element on the first thermal sheet.

17. The pouch cell assembly of claim 16, wherein the first thermal sheet and the second thermal sheet comprise graphite sheets.

18. The pouch cell assembly of claim 16, wherein the first thermal sheet and the second thermal sheet have thicknesses in a range from 0.01 millimeters to 0.10 millimeters.

19. The pouch cell assembly of claim 16, wherein the first thermal sheet has a bend that defines a portion of the first thermal sheet extending over the first edge toward the second surface, and
wherein the second thermal sheet has a bend that defines a portion of the second thermal sheet extending over the second edge toward the first surface.

20. The pouch cell assembly of claim 16, wherein the first thermal sheet and the second thermal sheet are attached to the pouch by adhesive.
